(19) United States
(12) Patent Application Publication
(10) Pub. No.: US 2010/0289179 A1
(43) Pub. Date: Nov. 18, 2010

(54) Texturized card

(75) Inventor: Eric Martin Virostek, Silver Lake, OH (US)

Correspondence Address: Giesecke & Devrient America, Inc., 45925 Horseshoe Drive, Dulles, VA, 20166, US

(73) Assignee: Giesecke & Devrient America, Inc., Dulles, VA (US)

(21) Appl. No.: 12/662,859

(22) Filed: May 6, 2010

Related U.S. Application Data
(60) Provisional application No. 61/213,097, filed on May 6, 2009.

(51) Int. Cl. B29C 59/02

(52) U.S. Cl. 264/241; 264/293

(57) ABSTRACT

A method of making a texturized card is disclosed. The method includes providing a card layer having a first surface and providing a release element having a second surface that is textured. The melting point of the release element has a temperature that is higher than the melting point temperature of the card layer. The method further includes positioning the release element against the card layer so that the second surface of the release element is in contact with the first surface of the card layer, then applying heat and pressure in sufficient quantity to enable the texture on the release element to be imparted to the first surface of the card layer. The release element is characterized as being suitable for a limited number of heat and pressure applications than available with a traditional texturized plate.

This application claims the benefit of U.S. Provisional Application No. 61/213,097, filed May 6, 2009, which is hereby incorporated by reference in its entirety.

### BACKGROUND

1. Field of the Invention

The present invention relates generally to cards. More particularly, the present invention relates to texturized cards having features relating to tactile and visual properties on at least one surface.

2. Description of the Related Art

A variety of cards formed of different shapes and materials are prevalent in today's marketplace. For example, cards are frequently used in applications involving transit, identification, security, and financial services, amongst many others. Generally, cards, which are typically planar, possess first and second surfaces having an area far in excess of card thickness. To distinguish amongst providers and applications, as well as to provide unique characteristics, cards can be manufactured with a design or image printed on one or both surfaces. Additional elements such as magnetic stripes, integrated circuits or microchips, holographic security features, etc., may be disposed on or near a card surface or within with card itself. Additionally, cards can be formed having alphanumeric characters embossed on a surface, as is typically done in the personalization of financial transaction cards. Traditional cards lack, however, texturization on one or both surfaces to provide visual and/or tactile properties. What is needed, therefore, is a method and apparatus for imparting texturization on one or more card surfaces.

### SUMMARY

The present invention has been developed to address the above and other problems in the related art. According to exemplary embodiments of the present invention, a heating apparatus is disclosed that includes a first region containing a heat source, a second region that is separate from and thermally coupled with the first region via an interface element, and a convection deflector. The convection deflector is disposed within the interior of the first region to direct heat towards the interface element. The deflector can have a geometric shaped cross-section with a front side oriented towards the heat source and an opposing rear side oriented away from the heat source. The front and rear sides are adapted to reflect radiant and convective heat.

According to exemplary embodiments of the present invention, a method of making a texturized card is disclosed. The method includes providing a card layer having a first surface and providing a release element having a second surface that is textured. The melting point of the release element has a temperature that is higher than the melting point temperature of the card layer. The method further includes positioning the release element against the card layer so that the second surface of the release element is in contact with the first surface of the card layer, then applying heat and pressure in sufficient quantity to enable the texture on the release element to be imparted to the first surface of the card layer. The release element is characterized as being suitable for a limited number of heat and pressure applications than available with a traditional texturized plate.

Exemplary embodiments of the present invention further disclose a method of making a texturized card. The method includes providing a plurality of card layers, at least one of the layers comprises a polymeric material, one of which being a receiving layer and having a first surface. The method further includes providing a release element having a second surface that is textured. The melting point of the release element has a temperature that is higher than the melting point temperature of the polymeric receiving layer. The method further includes positioning the release element against the polymeric receiving layer so that the textured second surface of the release element is in contact with the first surface of the polymeric receiving layer, then applying heat and pressure to the card layers and release element at sufficient levels to enable the texture on the release element to be imparted to the first surface of the polymeric receiving layer. The release element is characterized as being suitable for a limited number of heat and pressure applications, the number being less than that available with a traditional texturized plate.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF THE DRAWINGS

The above and/or other exemplary features and advantages of the preferred embodiments of the present invention will become more apparent through the detailed description of exemplary embodiments thereof with reference to the accompanying drawings, in which:

FIG. 1 illustrates a sectional view of a card layer and release element in accordance with an embodiment of the present invention;

FIG. 2 is a flow diagram of a texturized card fabrication process in accordance with an embodiment of the present invention;

FIG. 3 depicts texturized cards made in accordance with the embodiment of FIG. 2;

FIG. 4 illustrates a sectional view of a plurality of card layer and release element combinations in accordance with an embodiment of the present invention; and

FIG. 5 is a flow diagram of a texturized card fabrication process in accordance with an embodiment of the present invention.

Throughout the drawings, like reference numbers and labels should be understood to refer to like elements, features, and structures.

### DETAILED DESCRIPTION

Exemplary embodiments of the present invention will now be described more fully with reference to the accompanying drawings. The matters exemplified in this description are provided to assist in a comprehensive understanding of various embodiments of the present invention disclosed with reference to the accompanying figures. Accordingly, those of ordinary skill in the art will recognize that various changes and modifications of the embodiments described herein can be made without departing from the scope and spirit of the claimed invention. Descriptions of well-known functions and constructions are omitted for clarity and conciseness. To aid in clarity of description, the terms “upper,” “lower,” “above,” “below,” “left” and “right,” as used herein, provide reference with respect to orientation of the accompanying drawings and are not intended to be limiting.

In the manufacture of cards, it is occasionally desirable to produce a card that has a textured surface. Traditionally, lamination plates, which are normally smooth, are worked so as to receive a textured pattern. For example, a die maker will dispose a graphic pattern on a lamination plate in a manner available to those having ordinary skill in the art, such as etching, engraving, photo-lithography, or other like methods. The lamination plate may be made from a variety of metals, such as magnesium, copper, bronze, chrome-plated metal, stainless steel, or other like metals. Although such traditional lamination plates are quite durable, lasting many processing life cycles, they are expensive to produce and the time required to impart a particular texture or design and have it available for production can be very lengthy. Accordingly, a need therefore exists for the ability to rapidly introduce various textures and designs in the card manufacturing process without the need to custom form lamination plates.

In accordance with exemplary embodiments of the present invention, a release element, which has a textured pattern disposed on at least one of its surfaces, is used to slip over a lamination plate such that a textured side is facing the card material. On application of heat and pressure the textured pattern from the release element with impart to the card material. It is anticipated, though not essential, that the release element will be formed of a material that is less expensive, and likely less durable, than the lamination plate. Accordingly, the release element will have a limited operational life relative to that of the lamination plate. Exemplary embodiments provide for a disposable release element that can be discarded after a limited number of uses. One advantage that a release element has over a traditional lamination plate is that the release element can be quickly and inexpensively produced, thus facilitating rapid design changes.

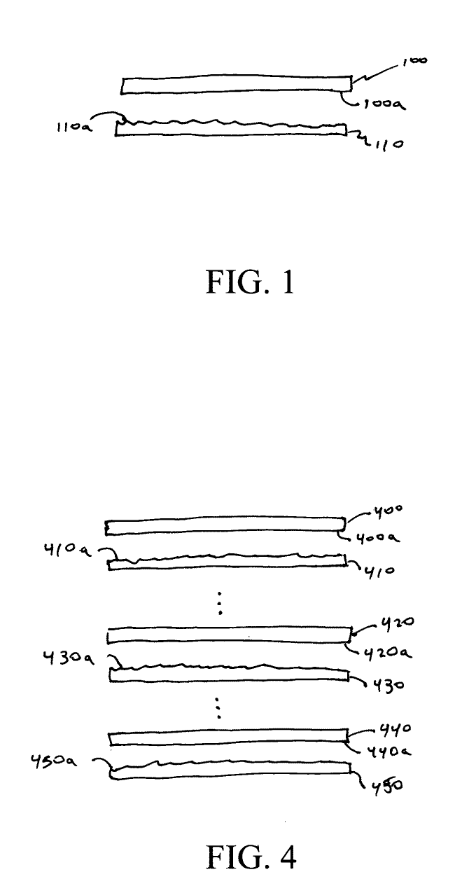

FIG. 1 illustrates a sectional view of a card layer and release element in accordance with an embodiment of the present invention. Referring to FIG. 1, card layer 100, having first surface 100a, and release element 110, having second surface 110a, are shown in a position with second surface 110a facing towards first surface 100a. Card layer 100 can be any material suitable for card manufacture. For example, card layer 100 can be made of plastic, vinyl, paper, glass, fiberglass, sheet metal, etc. Although it is anticipated that a texturized card will be formed of multiple layers, thus card layer 100 being one of a plurality of layers, card layer 100 can also be the only layer of the card. Exemplary embodiments provide card layer 100 as being made of a polymeric material. Generally, cards, which are typically planar, possess front and back surfaces having an area far in excess of card thickness. Exemplary embodiments provide for a texturized card that is substantially planar. Cards are frequently used in applications involving transit, identification, security, and financial services, amongst many others.

Release element 110 can be made from plastic or vinyl, paper, glass, sheet metal, or any material upon which a texture can be formed. Exemplary embodiments provide the release element 110 as being made of paper with a textured side (second surface 110a) and a paper backing. The material comprising release element 110 should be, however, of a nature such that release element 110 has a melting point temperature that is higher than the melting point temperature of card layer 100. In operation, heat will be applied at a level sufficient to soften the card layer 100 material so that on application of adequate pressure the texture from release element 110 will be imparted into the first surface of card layer 100.

The texture of second surface 110a can be formed of various shapes and designs or, alternatively, can be smooth. A release element 110 having a smooth surface would be useful in situations where a lamination plate has been damaged, thus requiring a covering to protect the card layer 100 during the lamination process. The textured design on release element 110 can be any pattern known to those of ordinary skill in the art and can be disposed substantially continuous across the second surface of the release element 110 or it can be discontinuous such that the textured area can cover an entire surface of the completed card or can be limited to specific regions of the surface in various patterns. In either case, the pattern can form indicia, such as a graphic depiction or lettering, or can be various shapes and icons.

Exemplary embodiments provide for the card layer and release element to comprise a combination whereby a plurality of card layer and release element combinations can be assembled for the simultaneous processing of multiple texturized cards.

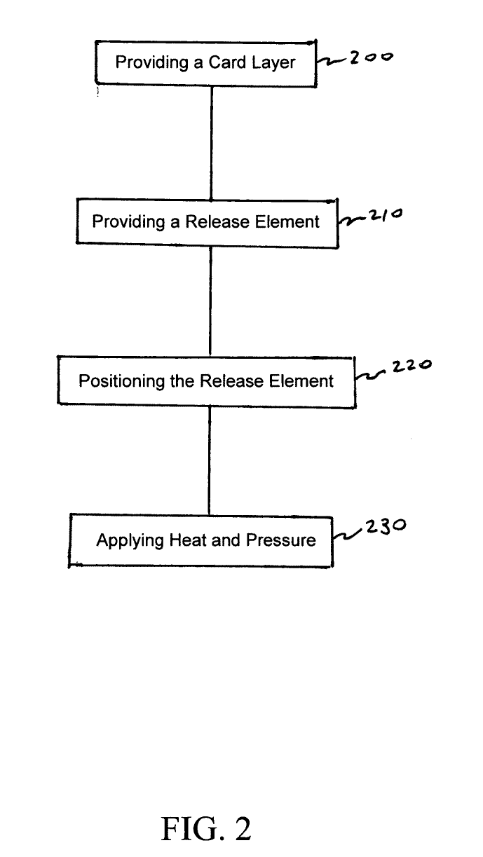

FIG. 2 is a flow diagram of a texturized card fabrication process in accordance with an embodiment of the present invention. At step 200, a card layer 100 having a first surface 110a is provided. At step 210, a release element 110 is provided that has a textured second surface 110a, the melting point temperature of the release element 110 being higher than the melting point temperature of the card layer 100. At step 220, the release element 110 is positioned against card layer 100 so that the textured second surface 110a is in contact with the first surface 110a of card layer 100. At step 230, heat and pressure are applied to card layer 100 and release element 110 at sufficient levels to enable the texture of the second surface 110a of the release element 110 to be imparted to the first surface 110a of the card layer 100. The release element 110 is suitable for a limited number of heat and pressure applications, the limited number being less than that available with a traditional texturized lamination plate.

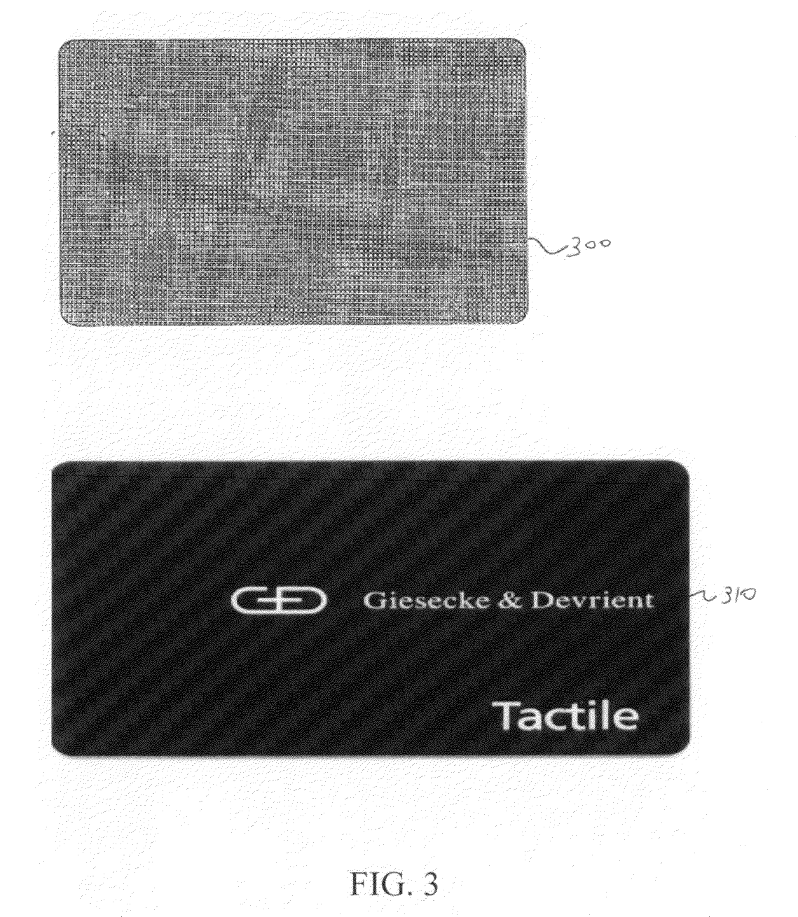

FIG. 3 depicts texturized cards made in accordance with the embodiment of FIG. 2. Card 300 illustrates a card made with a card layer 100 having a textured pattern disposed continuously across the surface. Card 310 illustrates a card made with a card layer 100 having a textured pattern comprising a logo and lettering in addition to a geometric shape.

FIG. 4 illustrates a sectional view of a plurality of card layer and release element combinations in accordance with an embodiment of the present invention. Each combination comprises a card layer and release element as described with FIG. 1 above. Shown in FIG. 4. are combinations 400/410, 420/430, and 440/450, each card layer having a first surface and each release element having a textured second surface, 400a/410a, 420a/430a, 440a/450a, respectively. Additional or fewer card layer/release element combinations can be provided as desired. As discussed with FIG. 1 above, each combination has the release element positioned against the card layer so that the textured second surface of each release element is in contact with the first surface of each card layer. Heat and pressure are applied to the plurality of card layer and release element combinations at sufficient levels to enable the texture of the second surface of each release element to be imparted to the first surface of each card layer. The release elements 410, 430, and 450 are suitable for a limited number of heat and pressure applications, the limited number being less than that available with a traditional texturized lamination plate. One advantage of assembling a collection of card layer/release element combinations is that the assembly forms a book that can process multiple cards simultaneously.

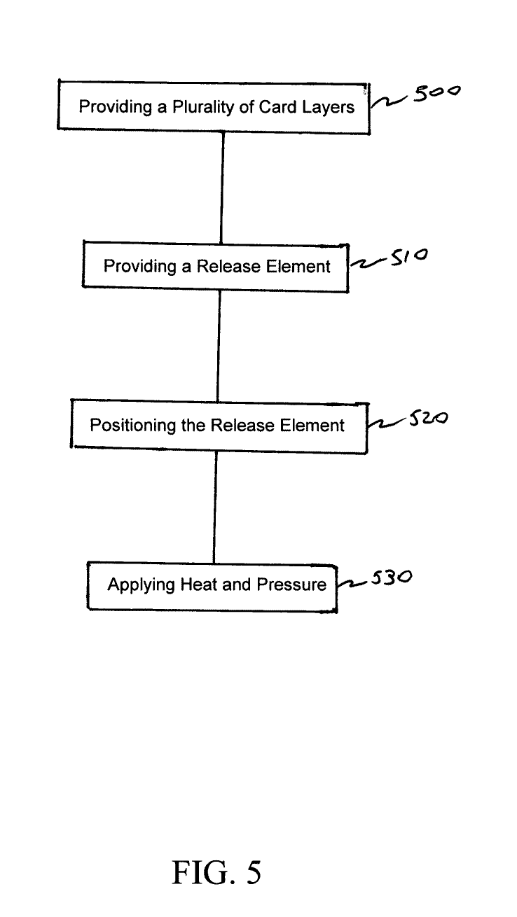

FIG. 5 is a flow diagram of a texturized card fabrication process in accordance with an embodiment of the present invention. At step 500, a plurality of card layers 100 are provided, at least one of the layers comprising a polymeric material, of which one has a first surface 110a that serves to receive texturization. At step 510, a release element 110 is provided that has a textured second surface 110a, the melting point temperature of the release element 110 being higher than the melting point temperature of the polymeric receiving layer. At step 520, the release element 110 is positioned against the polymeric receiving layer so that the textured second surface 110a is in contact with the first surface 110a of the polymeric receiving layer. At step 530, heat and pressure are applied to the plurality of card layers 100 and release element 110 at sufficient levels to enable the texture of the second surface 110a of the release element 110 to be imparted to the first surface 110a of the polymeric receiving layer. The release element 110 is suitable for a limited number of heat and pressure applications, the limited number being less than that available with a traditional texturized lamination plate.

While the present invention has been particularly shown and described with reference to certain exemplary embodiments thereof, it will be understood by those of ordinary skill in the art that various changes in form and detail may be made therein without departing from the spirit and scope of the present invention as defined by the appended claims.

What is claimed is:

1. A method of making a texturized card, the method comprising:
providing a card layer having a first surface;
providing a release element having a second surface that is textured, said release element having a melting point temperature that is higher than the melting point temperature of said card layer;
positioning said release element against said card layer, wherein the textured second surface of said release element is in contact with the first surface of said card layer; and
applying heat and pressure to said card layer and said release element at sufficient levels to enable the texture of said release element second surface to be imparted to said card layer first surface,
wherein said release element is suitable for a limited number of heat and pressure applications, said limited number being less than that available with a texturized lamination plate.

2. The method of claim 1, wherein the card layer comprises polymeric material.

3. The method of claim 1, wherein the texture of said second surface of said receiving element is smooth.

4. The method of claim 1, wherein the texture of said second surface of said receiving element is patterned.

5. The method of claim 4, wherein the pattern is substantially continuous across the second surface of the release element.

6. The method of claim 4, wherein the pattern is discontinuous across the second surface of the release element.

7. The method of claim 5, wherein the pattern comprises indicia.

8. The method of claim 6, wherein the pattern comprises indicia.

9. The method of claim 1, said card layer and release element comprising a combination, the method further comprising assembling a plurality of card layer and release element combinations, each combination having the release element positioned against the card layer, wherein the textured second surface of each of said release elements is in contact with the first surface of each of said card layers; and
applying heat and pressure to the plurality of card layer and release element combinations at sufficient levels to enable the texture of the second surface of each of said release elements to be imparted to the first surface of each of said card layers,
wherein each of said release elements is suitable for a limited number of heat and pressure applications, said limited number being less than that available with a texturized lamination plate.

10. The method of claim 1, wherein the texturized card is substantially planar.

11. A method of making a texturized card, the method comprising:
providing a plurality of card layers, at least one of said layers comprises a polymeric material, one of which being a receiving layer and having a first surface;
providing a release element having a second surface that is textured, said release element having a melting point temperature that is higher than the melting point temperature of said polymeric receiving layer;
positioning said release element against said polymeric receiving layer, wherein the textured second surface of said release element is in contact with the first surface of said polymeric receiving layer; and
applying heat and pressure to said plurality of card layers and said release element at sufficient levels to enable the texture of said release element second surface to be imparted to the first surface of said polymeric receiving layer,
wherein said release element is suitable for a limited number of heat and pressure applications, said limited number being less than that available with a texturized lamination plate.

12. The method of claim 11, wherein the texturized card is substantially planar.

13. The method of claim 11, wherein the texture of said second surface of said receiving element is smooth.

14. The method of claim 11, wherein the texture of said second surface of said receiving element is patterned.

15. The method of claim 14, wherein the pattern is substantially continuous across the second surface of the release element.

16. The method of claim 14, wherein the pattern is discontinuous across the second surface of the release element.

17. The method of claim 15, wherein the pattern comprises indicia.

18. The method of claim 16, wherein the pattern comprises indicia.

19. The method of claim 11, said polymeric receiving layer and release element comprising a combination, the method further comprising assembling a plurality of polymeric receiving layer and release element combinations, each combination being associated with a respective plurality of card layers, each combination having the release element positioned against the polymeric receiving layer, wherein the textured second surface of each of said release elements is in contact with the first surface of each of said polymeric receiving layers; and
applying heat and pressure to the plurality of polymeric receiving layer and release element combinations at sufficient levels to enable the texture of the second surface of each of said release elements to be imparted to the first surface of each of said polymeric receiving layers,
wherein each of said release elements is suitable for a limited number of heat and pressure applications, said limited number being less than that available with a texturized lamination plate.
